(19) United States
(12) Patent Application Publication
(10) Pub. No.: US 2006/0187915 A1
(43) Pub. Date: Aug. 24, 2006

(54) Method and apparatus for updating a wireless telephone

(76) Inventors: Rami Caspi, Sunnyvale, CA (US); William J. Beyda, Cupertino, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/060,979

(22) Filed: Feb. 18, 2005

(51) Int. Cl. H04L 12/56; H04L 12/28

(52) U.S. Cl. 370/389

(57) ABSTRACT

A telecommunications system including a telephony device having telephony network and packet network connectivity and storing telephony device user data; a first personal computer having packet network connectivity and storing first user data; a second personal computer having packet network connectivity and storing second user data. The telephony device is configured to distinguish between packet network connectivity of said first personal computer and said second personal computer and receive said first user data and said second user data using said packet network connectivity and update said telephony device user data using said first user data and said second user data, wherein updating includes providing distinguishing indicia between said first user data and said second user data.

### BACKGROUND OF THE INVENTION

1. Field of the Invention

The present invention relate to telecommunications systems and, in particular, to an improved wireless telephone system.

2. Description of the Related Art

Home and office users are increasingly able to use their computers to store user data such as address or contact lists, calendar information, and task lists. In addition, in the modern telecommunications environment, users are increasingly dependent upon cellular telephones. In many cases, when the user is away from home or the office, the cellular telephone is the user's only available telecommunications device. Some cellular telephones allow the user to store personal data, including address lists.

Thus, a user may have personal data on two, three or more devices. Often, the user may have need of information on one such device, but find it has not been stored on another. Moreover, with the multiplication of devices, it becomes increasingly difficult to maintain a comprehensive, current store of personal data.

### SUMMARY OF THE INVENTION

These and other drawbacks in the prior art are overcome in large part by a system and method according to embodiments of the present invention.

A telecommunications system according to an embodiment of the present invention includes a telephony device having telephony network and packet network connectivity and storing telephony device user data; a first personal computer having packet network connectivity and storing first user data; a second personal computer having packet network connectivity and storing second user data. The telephony device is configured to distinguish between packet network connectivity of said first personal computer and said second personal computer and receive said first user data and said second user data using said packet network connectivity and update said telephony device user data using said first user data and said second user data, wherein updating includes providing distinguishing indicia between said first user data and said second user data.

A telecommunication system according to embodiments of the present invention includes a wireless telephony device having wireless telephony connectivity; and a computer having wireless telephony connectivity and configured to run one or more wireless telephony device update applications for providing update data. The wireless telephony device is configured to receive said update data using said wireless telephony connectivity.

A wireless telephony device according to embodiments of the present invention includes a configuration controller for processing updatable configuration data; a memory for storing updatable configuration data; and a wireless interface for receiving said updatable configuration data. According to certain embodiments, the wireless interface is configured to receive updatable configuration data from a plurality of sources and said configuration controller is configured to distinguish between the sources when performing an update of said data.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram schematically illustrating a system according to embodiments of the present invention.

FIG. 2 is a diagram schematically illustrating a system according to embodiments of the present invention.

FIG. 3 illustrates an exemplary cell phone display according to an embodiment of the present invention.

FIG. 4 is a block diagram of an exemplary cellular telephone in accordance with embodiments of the present invention.

FIG. 5 illustrates an exemplary system according to an embodiment of the present invention.

FIG. 6 is a flowchart illustrating operation of an embodiment of the present invention.

FIG. 7 is a flowchart illustrating operation of an embodiment of the present invention.

FIG. 8 is a flowchart illustrating operation of an embodiment of the present invention.

FIG. 9 is a diagram of an exemplary system according to an embodiment of the present invention.

FIG. 10 is a block diagram of a server according to an embodiment of the present invention.

FIG. 11 is a flowchart illustrating operation of an embodiment of the present invention.

FIG. 12 is a flowchart illustrating operation of an embodiment of the present invention.

### DETAILED DESCRIPTION OF EMBODIMENTS OF THE INVENTION

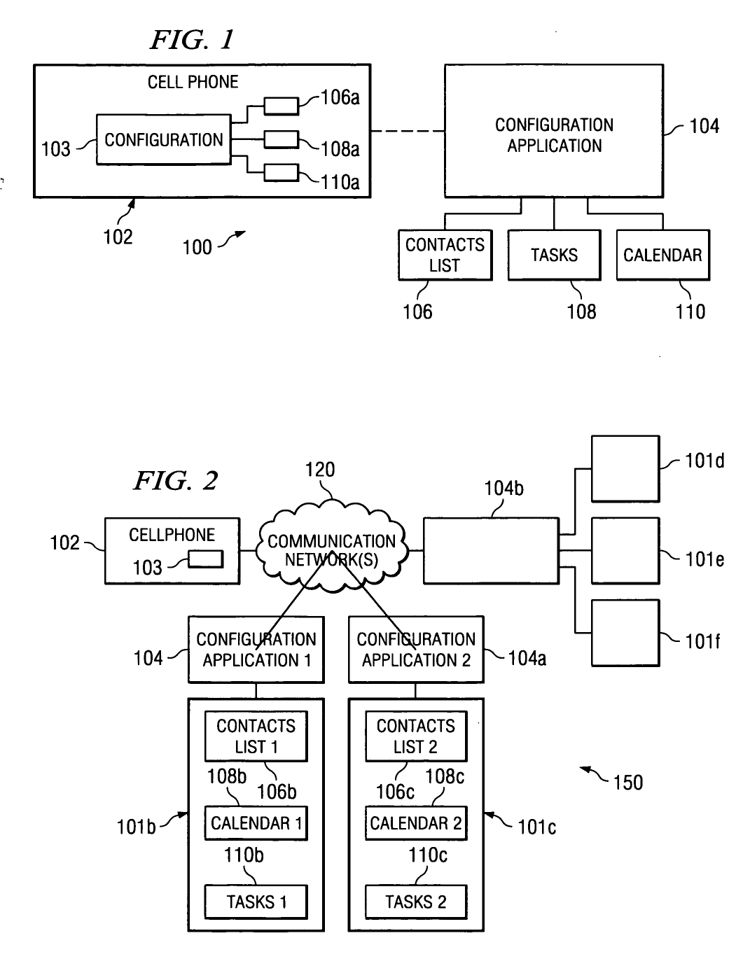

Turning now to the drawings and, with particular attention to FIG. 1, a diagram of a telecommunications system 100 according to an embodiment of the present invention is shown. The system includes a remote synchronization or configuration application 104 operably coupled to or in communication with a telephony device, for example, a wireless telephony device such as a cell phone 102. The cell phone 102 may be implemented as GPRS, GSM, or any of a variety of cell protocol capable telephones. In certain embodiments, the cell phone 102 may also include wireless Internet (WiFi) capabilities, such as those compatible with, for example, IEEE 802.11, Bluetooth, or IRDA. The cell phone 102 may further include a synchronization or configuration control unit (CCU) 103 in accordance with embodiments of the present invention. Such a CCU 103 may be implemented, for example, as one or more software and/or firmware modules running on a processor.

The CCU 103 may further be coupled to or in communication with one or more storage devices or databases for user data, including contacts lists 106a, task lists 108a, and calendars 110a. The databases may be updated using the CCU 103, as will be explained in greater detail below.

The configuration application 104 may also be coupled to or in communication with one or more sets of user data or databases 101 such as contacts lists 106b, task lists 108b, and calendars 110b. The configuration application 104 and the databases may be implemented in hardware and/or software operating on one or more servers, computer systems, host or mainframe computers, workstations, etc. In some embodiments, the configuration application 104 may be operating on some or all of the same devices as other components in the system 100.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

In some embodiments, the configuration application 104 may be or include an application that communicates with or is connected to one or more registered devices that allows devices to register with the system 100 or helps to facilitate their registration. For example, in a SIP environment, the devices may be registered with the system 100 and may show up or be described in registration databases as being assigned to particular identities.

In certain embodiments of the present invention, one or more of the components of the system 100 may be connected to or in communication with each other via a communication network. For example, turning now to FIG. 2, a system 150 including the components of the system 100 is illustrated, wherein some or all of the components are in communication via a network 122. A second configuration application 104a may also be coupled to the communication network. The configuration application 104a may likewise be coupled to or in communication with user data 101c, such as contacts list 106c, calendar 108c, and tasks 110c. In addition, a third configuration application 104b may also be coupled to the communication network. The configuration application 104b may be associated with a plurality of sets of user data 101d, 101e, 101f.

The network 122 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

As will be explained in greater detail below, in certain embodiments, the cell phone 102 can communicate over the network 122 with one or more of the configuration applications 104, 104a, 104b to update its user data. More particularly, in certain embodiments, the configuration application 104 may be associated with a user of cell phone 102, e.g., may be an office computer and configuration application 104a also may be associated with the user, e.g., may be a home computer. In other embodiments, the configuration application 104b may be associated with a server.

In certain embodiments, the cell phone 102 may be equipped with a wireless packet network (e.g., WiFi) controller, as will be explained in greater detail below, that allows communication with and distinguishing between, configuration applications. for example, the configuration application 104 and the configuration application 104a. The computer associated with configuration application 104 may be associated with or defined by a network identification the computer associated with configuration application 104a may be associated with or defined by a second network identification.

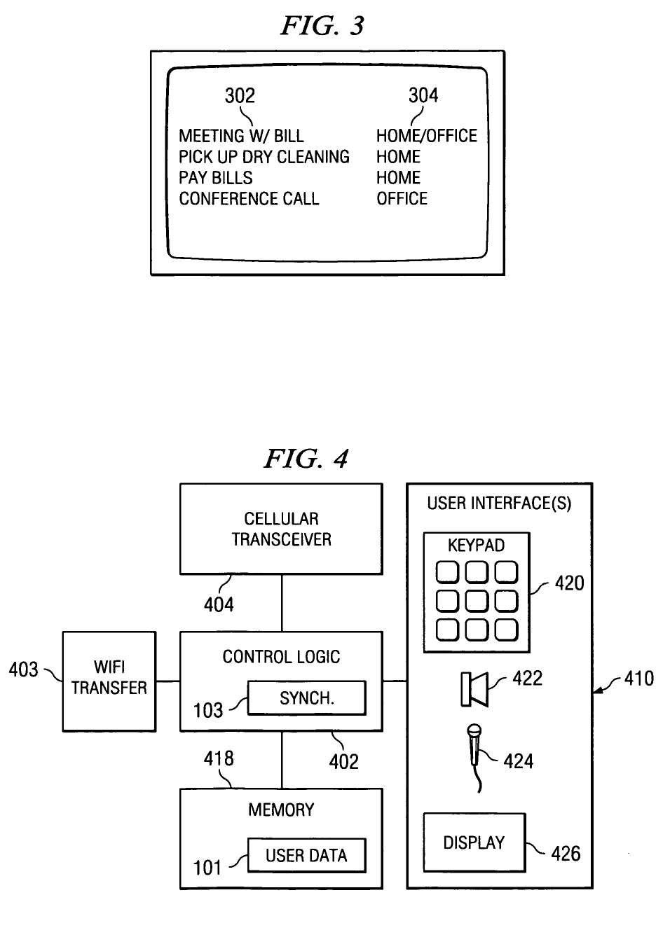

The cell phone WiFi controller can allow the cell phone 102 to log in to the computer and identify which computer it is logging into by the network identifiers. Then, when the CCU 103 receives the user data, it can display the data with indicia marking the data as from the home or office computer. For example, shown in FIG. 3 is an exemplary cell phone display 300.

The display shows an entry column 302 and a source column 304. The entry column lists one or more calendar, to-dos, or addresses. The source column 304 indicates whether the information originally came from home or office or both. In some embodiments, the cell phone itself can also be a source. In certain embodiments, the most recent entry or source can be highlighted.

In other embodiments, the cell phone 102 need implement only cell phone telephony-type connectivity (e.g., GPRS or UMTS) and not implement WiFi connectivity. Such an embodiment may be particularly suited for use with a configuration application 104b running on a server such as the Siemens IMS server.

An exemplary cellular telephone 400 including user data synchronization capabilities in accordance with an embodiment of the present invention is shown in FIG. 4. In some embodiments, the cellular telephone 400 may implement one or more elements of the methods disclosed herein. As shown, the cellular telephone includes control logic 402 and cellular transceiver 404. The cellular transceiver 404 allows communication over a cellular telephone network, such as a GSM or GPRS based cellular telephone network. The control logic 402 generally controls operation of the cellular telephone and includes a synchronization control (CCU) 103 in accordance with embodiments of the present invention.

The control logic interfaces to a memory 418 for storing, among other things, program controls and user data; user interface(s) 410; and may also interface to a WiFi controller 403 to allow wireless Internet access. The user interface(s) 410 can include a keypad 420, speaker 422, microphone 424, and display 426. The keypad may include one or more “hard” keys and may be implemented in whole or in part as a cursor pointing device in association with one or more “virtual” keys on the display 426. It is noted that other interfaces, such as voice activated interfaces may be provided. Thus, the figure is exemplary only.

As noted above, the control logic 402 may implement a synchronization control 103. The control logic 402 may be implemented as various combinations of hardware, software, or firmware and, in particular, may be implemented as one or more control processors.

In certain embodiments, the control logic 402 allows communication with one or more computers via the WiFi control unit 403. The control logic 402 can identify the source of uploaded data from the corresponding network identification(s). The synchronization unit 103 can then cause incoming data to be displayed on the display, with appropriate indicia identifying the home or office (or cell phone) source of the particular data.

Additionally, in certain embodiments, the control logic can synchronize between different sources of user data by identifying “most recently updated” data items and determine whether there are inconsistencies and/or discrepancies in particular items. If so, the synchronization unit 103 can identify these to the user or change them, as appropriately configured.

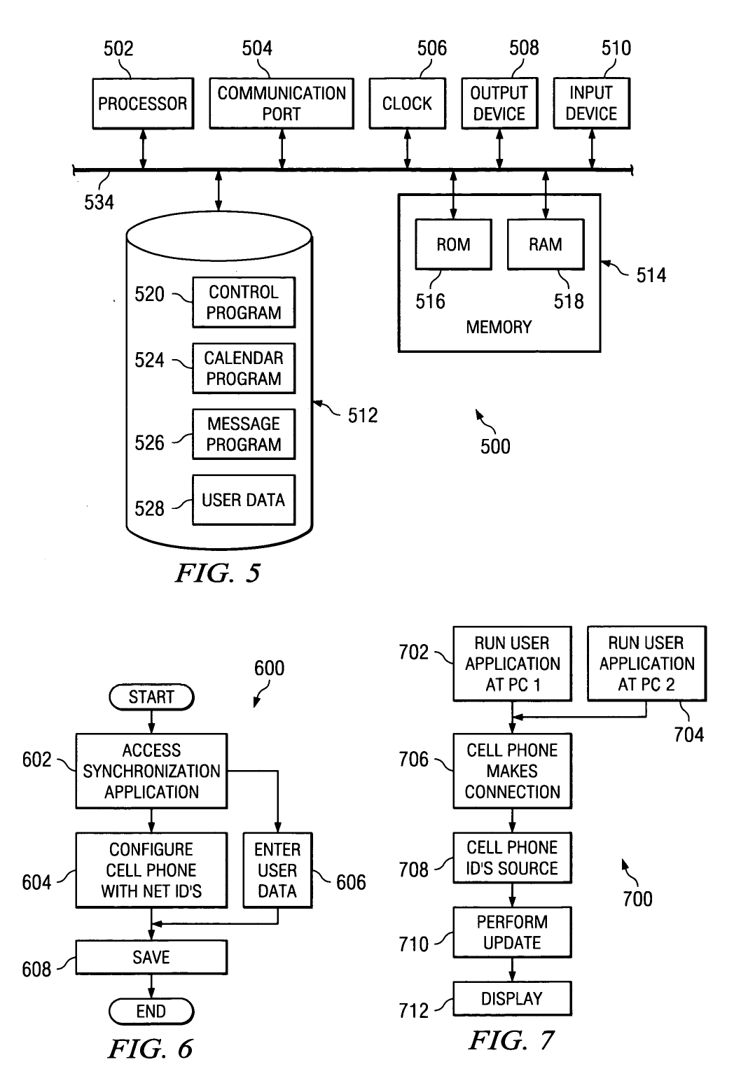

Now referring to FIG. 5, a representative block diagram of a computer or processing device 500 suitable for use as a user device according to embodiments of the present invention is shown. In particular, the computer 500 may be a device suitable for setting one or more sets of user data and may implement one or more configuration applications. Thus, in some embodiments, the computer 500 may include or operate a configuration application 104. The computer 500 may be embodied as a single device or computer, a networked set or group of devices or computers, a workstation, mainframe or host computer, etc. In some embodiments, the computer 500 may implement one or more elements of the methods disclosed herein (such as those associated with a first personal computer 500a and a second personal computer 500b, not shown, implementing configuration applications 104, 104a).

The computer 500 may include a processor, microchip, central processing unit, or computer 502 that is in communication with or otherwise uses or includes one or more communication ports or network interfaces 504 for communicating with user devices and/or other devices. The communication ports 504 may include such things as local area network adapters, wireless communication devices, Bluetooth technology, etc. The computer 500 also may include an internal clock element 506 to maintain an accurate time and date for the computer 500, create time stamps for communications received or sent by the computer 500, etc.

If desired, the computer 500 may include one or more output devices 508 such as a printer, infrared or other transmitter, antenna, audio speaker, display screen or monitor, text to speech converter, etc., as well as one or more input devices 510 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 500 may include a memory or data storage device 512 to store information, software, databases, documents, communications, device drivers, etc. The memory or data storage device 512 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 512 may include various combinations of moveable and fixed storage. The computer 500 also may include memory 514, such as ROM 516 and RAM 518.

The processor 502 and the data storage device 512 in the computer 500 each may be, for example: (i) located entirely within a single computer or other computing device; or (ii) connected to each other by a remote communication medium, such as a serial port cable, telephone line or radio frequency transceiver. In one embodiment, the computer 500 may be implemented as one or more computers that are connected to a remote server computer.

A conventional personal computer or workstation with sufficient memory and processing capability may be used as the computer 500. The computer 500 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 502. Other suitable processors may be available from Motorola, Inc., AMD, or Sun Microsystems, Inc. The processor 502 also may be embodied as one or more microprocessors, computers, computer systems, etc.

Software may be resident and operating or operational on the computer 500. The software may be stored on the data storage device 512 and may include a client control program 520 for operating the computer. The client control program 520 may include or interface to a calendar program 524, and a communications program 526. The software may also include user data 528 such as calendar data, task lists, or contacts.

The client control program 520 may control the processor 502. The processor 502 may perform instructions of the client control program 520, and thereby operate in accordance with the methods described in detail herein. The client control program 520 may be stored in a compressed, uncompiled and/or encrypted format. The client control program 520 furthermore includes program elements that may be necessary, such as an operating system, a database management system and device drivers for allowing the processor 502 to interface with peripheral devices, databases, etc. Appropriate program elements are known to those skilled in the art, and need not be described in detail herein.

The computer 500 also may include or store user information 524, such as information regarding identities, user devices, contexts, presence information, communications, etc. Such user data 524 may be provided from other applications, such as the calendar program 524. Information regarding other application program data may be stored in application databases (not shown)

According to some embodiments, the instructions of the control program may be read into a main memory from another computer-readable medium, such as from the ROM 516 to the RAM 518. Execution of sequences of the instructions in the control program causes the processor 502 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 502, communication ports 504, clock 506, output device 508, input device 510, data storage device 512, ROM 516 and RAM 518 may communicate or be connected directly or indirectly in a variety of ways. For example, the processor 502, communication ports 504, clock 506, output device 508, input device 510, data storage device 512, ROM 516 and RAM 518 may be connected via a bus 534.

While specific implementations and hardware/software configurations for the computer 500 have been illustrated, it should be noted that other implementations and hardware configurations are possible and that no specific implementation or hardware/software configuration is needed. Thus, not all of the components illustrated in FIG. 5 may be needed for the computer 800 implementing the methods disclosed herein.

Turning now to FIG. 6, a flowchart 600 illustrating operation of an embodiment of the present invention is shown. The particular arrangement of elements in the flowchart 600 is not meant to imply a fixed order to the elements; embodiments can be practiced in any order that is practicable.

In a step 602, the user can access the synchronization application 103 on his cell phone. Such access can include, for example, using the user interface 410 (FIG. 4) to access one or more applications or control programs. In a step 604, the user can configure the cell phone with the network identification of the home and office computers. The user can also, in a step 606, enter user data, such as calendar or schedule information, addresses, and the like. For example, the user can open a calendar program and store “to-do” lists or meeting times, and the like. The synchronization application 103 can receive and store the data, in a step 608.

Turning now to FIG. 7, a flowchart 700 illustrating operation of an embodiment of the present invention is shown. The particular arrangement of elements in the flowchart 700 is not meant to imply a fixed order to the elements; embodiments can be practiced in any order that is practicable.

In a step 702, the user can access his first computer to add or change user data. For example, a user can make use of one or more application programs on a home computer. In a step 704, the user can do the same at his second computer, such as a work computer. The user data may be received or stored by the configuration application running on the respective computer. Such user data may, for example, be “drag and dropped” in the appropriate manner.

In a step 706, the cell phone can be used to make a wireless connection to one or the other of the computers. As noted above, the cell phone's WiFi controller can be used to make a wireless packet network connection to one or the other of the computers. In a step 708, the cell phone compares the network IDs with the ones initialized, to determine the source (i.e., the home or office computer). In a step 710, the synchronization controller 103 will perform an update of the contact information. For example, in certain embodiments, the cell phone will store the user data according to type. Finally, in a step 712, the synchronization unit 103 will cause the newly added information to be displayed. In certain embodiments, as noted above, the data can be displayed with appropriate indicia indicative of the source of the data.

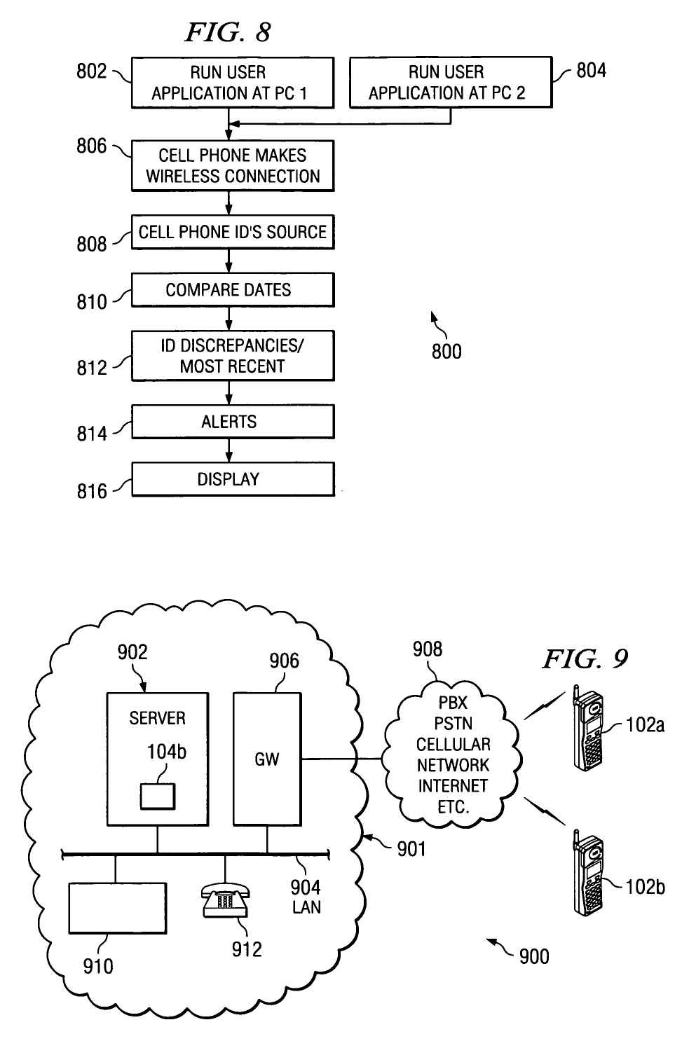

Turning now to FIG. 8, a flowchart 800 illustrating operation of an embodiment of the present invention is shown. The particular arrangement of elements in the flowchart 800 is not meant to imply a fixed order to the elements; embodiments can be practiced in any order that is practicable.

In a step 802, the user can access his first computer to add or change user data. For example, a user can make use of one or more application programs on a home computer. In a step 804, the user can do the same at his second computer, such as a work computer. In a step 806, the cell phone can be used to make a wireless connection to one or the other of the computers. Again, as noted above, this can be accomplished using the WiFi controller. In a step 808, the cell phone compares the network Ids with the ones initialized, to determine the source.

In a step 810, the synchronization controller 103 will determine if any of the newly downloaded data is newer than the existing data. For example, the data may be provided with a date stamp that can be read by the synchronization controller 103. In a step 812, the synchronization controller 103 can determine which, if any, has been saved most recently and, in certain embodiments, compare the data to the saved data. In a step 814, the synchronization controller 103 can provide an alert indicating one or more discrepancies between entries. In a step 816, the synchronization controller can perform an update (either automatically or in response to a user input) and display. Alternatively, the synchronization controller can display, but with suitable indicia indicative of the discrepancies.

As noted above, in certain embodiments of the present invention, the synchronization application of the cellular telephone may be in communication with configuration application running on a server. The communication itself may be via the cellular telephone network.

An exemplary network architecture that may be suitable for use with embodiments of the present invention is shown in FIG. 9. As shown, the system 900 includes an enterprise network 901 and a public network 908. The enterprise network 901 may include a wired or wireless local area network (LAN) 904. A server 902 that may be embodied as synchronization server implementing a configuration program 104b may be coupled to the LAN 304. An exemplary server is the Siemens Openscape presence server, available from Siemens Corporation.

Also coupled, connected to or in communication with the LAN 904 may be one or more user devices 910, 912. The user devices 910, 912 may be implemented as personal computers 910 or digital telephones 912, such as Internet Protocol (IP) based digital telephones.

An exemplary personal computer 910 may be similar to the computer of FIG. 5 and may also include user applications and user data, which can be used to set user information on the server 902. A gateway 906 may also be coupled to the LAN 904. The gateway 906 provides an interface to the public network 908, which may be implemented as one or more of the PSTN, cellular telephone network, Internet, one or more PBX's, and the like. One or more user devices 102, which may be implemented as one or more cellular telephones, may be in communication with the public network 908.

In operation, a user can configure his cellular telephone to communicate with the server to receive user data from the associated computer. The cellular telephone of FIG. 9 may be generally similar to the cellular telephone of FIG. 4, although certain embodiments need not include the WiFi control; communication may be done over the cellular network according to cellular telephone protocols.

Various information may be set by the user or automatically by the system. The information may be set by the user using his client 310 at his personal computer 110. The information is then received by the server and made available to other user devices, such as a cellular telephone equipped with a synchronization application according to embodiments of the present invention. The client 310 may include, for example, a web-browser.

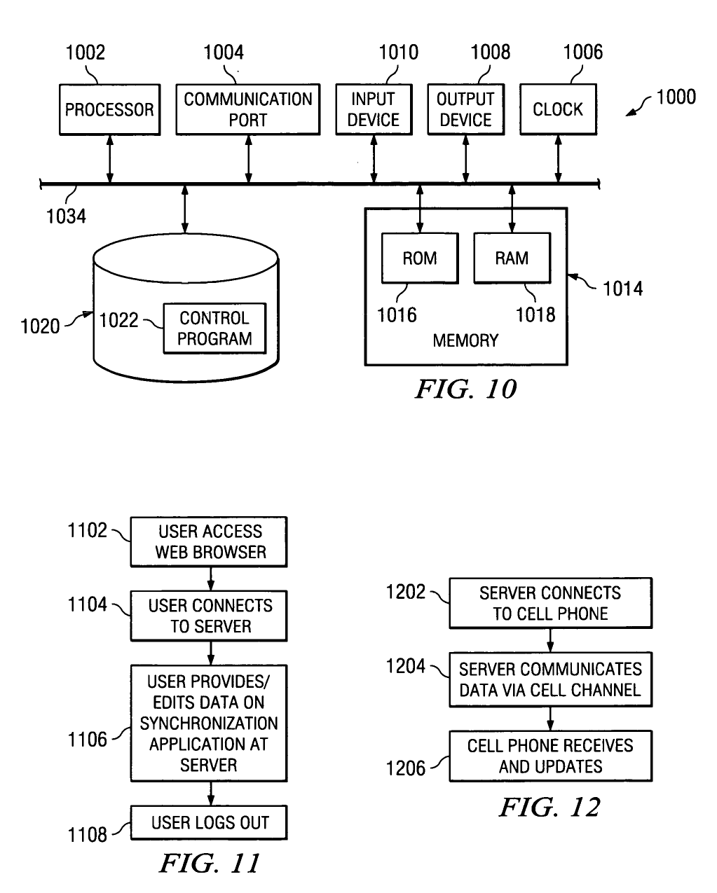

FIG. 10 is a diagram illustrating a server 1000 according to embodiments of the present invention. The server 1000 may be representative, for example, of the server 902 (FIG. 9). In some embodiments, the server 1000 may include or operate user programs, including, for example, communications and calendar programs. The server 1000 may be embodied as a single device or computer, a networked set or group of devices or computers, a workstation, mainframe or host computer, etc. In some embodiments, the server 1000 may implement one more elements of the methods disclosed herein.

The server 1000 may include a processor, microchip, central processing unit, or computer 1002 that is in communication with or otherwise uses or includes one or more communication ports 1004 for communicating with user devices and/or other devices. The communication ports 1004 may include such things as local area network adapters, wireless communication devices, telephone network adapters, Bluetooth technology, etc. The server 1000 also may include an internal clock element 1006 to maintain an accurate time and date for the server 1000, create time stamps for communications received or sent by the server 1000, etc.

If desired, the server 1000 may include one or more output devices 1008 such as a printer, infrared or other transmitter, antenna, audio speaker, display screen or monitor, text to speech converter, etc., as well as one or more input devices 1010 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 1000 may include a memory or data storage device 1020 to store information, software, databases, documents, communications, device drivers, etc. The memory or data storage device 1020 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 1000 also may include memory 1014, such as ROM 1016 and RAM 1018.

The processor 1002 and the data storage device 1020 in the server 1000 each may be, for example: (i) located entirely within a single computer or other computing device; or (ii) connected to each other by a remote communication medium, such as a serial port cable, telephone line or radio frequency transceiver. In one embodiment, the server 1000 may be implemented as one or more computers that are connected to a remote server computer for maintaining databases.

A conventional personal computer or workstation with sufficient memory and processing capability may be used as the server 1000. The server 1000 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1002. Other suitable processors may be available from Motorola, Inc., AMD, or Sun Microsystems, Inc. The processor 1002 also may be embodied as one or more microprocessors, computers, computer systems, etc.

Software may be resident and operating or operational on the server 1000. The software may be stored on the data storage device 1020 and may include a control program 1022 for operating the server, databases, etc. The control program 1022 may include or interface to the communication and user data programs.

The control program 1022 may control the processor 1002. The processor 1002 may perform instructions of the control program 1020, and thereby operate in accordance with the methods described in detail herein. The control program 1022 may be stored in a compressed, uncompiled and/or encrypted format. The control program 1022 furthermore includes program elements that may be necessary, such as an operating system, a database management system and device drivers for allowing the processor 1002 to interface with peripheral devices, databases, etc. Appropriate program elements are known to those skilled in the art, and need not be described in detail herein.

The server 1000 also may include or store information regarding identities, user devices, contexts, presence information, communications, outgoing default messages, etc. For example, information regarding one or more identities may be stored in an identity information database 1024 for use by the server 1000 or another device or entity. Information regarding one or more identity or device contexts may be stored in a context information database for use by the server 1000 or another device or entity; information regarding presence rules may be stored in a presence information database 1026 for use by the server 1000 or another device or entity; and information regarding other application program data may be stored in application database (not shown). In some embodiments, some or all of one or more of the databases may be stored or mirrored remotely from the server.

According to some embodiments, the instructions of the control program may be read into a main memory from another computer-readable medium, such as from the ROM 1016 to the RAM 1018. Execution of sequences of the instructions in the control program causes the processor 1002 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1002, communication ports 1004, clock 1006, output device 1008, input device 1010, data storage device 1012, ROM 1016, and RAM 1018 may communicate or be connected directly or indirectly in a variety of ways. For example, the processor 1002, communication ports 1002, clock 1006, output device 1008, input device 1010, data storage device 1012, ROM 1016, and RAM 1018 may be connected via a bus 034.

While specific implementations and hardware/software configurations for the server 1000 have been illustrated, it should be noted that other implementations and hardware configurations are possible and that no specific implementation or hardware/software configuration is needed. Thus, not all of the components illustrated in FIG. 10 may be needed for the server 1000 implementing the methods disclosed herein.

Turning now to FIG. 11, a flowchart 1100 illustrating operation of an embodiment of the present invention is shown. The particular arrangement of elements in the flowchart 1100 is not meant to imply a fixed order to the elements; embodiments can be practiced in any order that is practicable.

In a step 1102, the user can access a web browser on his personal computer 910. The user can the connect to the server 902, in a step 1004. In a step 1106, the user can user the browser to access programs associated with user data, such as calendar and messaging programs. In a step 1108, the user can save and log out.

Turning now to FIG. 11, a flowchart 1100 illustrating operation of an embodiment of the present invention is shown. The particular arrangement of elements in the flowchart 1100 is not meant to imply a fixed order to the elements; embodiments can be practiced in any order that is practicable.

In a step 1202, the cell phone can connect to the server. For example, the cell phone can dial a particular number at the server associated with uploading configuration, etc., information or system updates. In a step 1204, the server communicates the user data to the cell phone via the cellular channel. Finally, in a step 1206, the cell phone receives the data and updates its own storage, in a manner generally similar to that discussed above.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A telecommunications system, comprising:
a telephony device having telephony network and packet network connectivity and storing telephony device user data;
a first personal computer having packet network connectivity and storing first user data;
a second personal computer having packet network connectivity and storing second user data;
wherein said telephony device is configured to distinguish between packet network connectivity of said first personal computer and said second personal computer and receive said first user data and said second user data using said packet network connectivity and update said telephony device user data using said first user data and said second user data, wherein updating includes providing distinguishing indicia between said first user data and said second user data.

2. A telecommunications system in accordance with claim 1, wherein the packet network is a wireless Internet-type network.

3. A telecommunications system in accordance with claim 2, wherein the first and second user data are calendar data.

4. A telecommunications system in accordance with claim 2, wherein the first and second user data are contact list data.

5. A telecommunications system in accordance with claim 2, wherein telephony device packet network connectivity comprises at least one of IEEE 802.11, Bluetooth, or IRDA connectivity.

6. A telecommunication system, comprising:
a wireless telephony device having wireless telephony connectivity; and
a computer having wireless telephony connectivity and configured to run one or more wireless telephony device update applications for providing update data;
wherein the wireless telephony device is configured to receive said update data using said wireless telephony connectivity.

7. A telecommunications system in accordance with claim 6, wherein the computer comprises a server coupled to an Internet-type network.

8. A telecommunications system in accordance with claim 7, wherein the update data comprises calendar data.

9. A telecommunications system in accordance with claim 7, wherein the update data includes contact list data.

10. A telecommunications system comprising:
a wireless telephony device;
a remote synchronization application; and
means for wirelessly transferring synchronization data from said remote synchronization application to said wireless telephony device.

11. A telecommunications system in accordance with claim 10, wherein the remote synchronization application receives data from an Internet-type network.

12. A telecommunications system in accordance with claim 10, wherein the wirelessly transferring means comprises means fro transferring via a cellular telephony network.

13. A telecommunications system in accordance with claim 10, wherein the wirelessly transferring means comprises means for transferring via a wireless Internet type network.

14. A telecommunications system in accordance with claim 10, said wirelessly transferring means including means for distinguishing between data from a first remote synchronization application and a second remote synchronization application.

15. A wireless telephony device comprising:
a configuration controller for processing updatable configuration data;
a memory for storing updatable configuration data; and
a wireless interface for receiving said updatable configuration data.

16. A wireless telephony device in accordance with claim 15, wherein the wireless interface is a wireless cellular telephony interface.

17. A wireless telephony device in accordance with claim 15, wherein the wireless interface is a wireless packet network interface.

18. A wireless telephony device in accordance with claim 15, wherein the wireless interface is configured to receive updatabale configuration data from a plurality of sources and said configuration controller is configured to distinguish between the sources when performing an update of said data.
